(19) United States
(12) Patent Application Publication
(10) Pub. No.: US 2014/0324974 A1
(43) Pub. Date: Oct. 30, 2014

(54) METHOD AND APPARATUS FOR PERFORMING DISTRIBUTED RESOURCE SCHEDULING IN DEVICE-TO-DEVICE COMMUNICATION SYSTEM

(71) Applicant: Samsung Electronics Co., Ltd., Suwon-si (KR)

(72) Inventors: Seung-Hoon PARK, Seoul (KR); Kyung-Kyu KIM, Suwon-si (KR); Dae-Gyun KIM, Seongnam-si (KR); Chi-Woo LIM, Suwon-si (KR)

(73) Assignee: Samsung Electronics Co., Ltd., Suwon-si (KR)

(21) Appl. No.: 14/264,396

(22) Filed: Apr. 29, 2014

(30) Foreign Application Priority Data
Apr. 29, 2013 (KR) 10-2013-0047423

(51) Int. Cl. H04L 29/08; H04W 28/16

(52) U.S. Cl. CPC H04L 67/1074; H04W 28/16
USPC 709/204

(57) ABSTRACT

A distributed scheduling method in a Device-to-Device (D2D) communication system is provided. The method includes transmitting, to a peer device, first resource information including a link identifier and start position information of resources to be allocated, receiving, from the peer device, second resource information in which at least one of the resource start position information and a resource allocation amount is adjusted based on the first resource information, and determining the resource start position based on the first resource information and second resource information.

### CROSS-REFERENCE TO RELATED APPLICATION(S)

This application claims the benefit under 35 U.S.C. §119(a) of a Korean patent application filed on Apr. 29, 2013 in the Korean Intellectual Property Office and assigned Serial number 10-2013-0047423, the entire disclosure of which is hereby incorporated by reference.

### TECHNICAL FIELD

The present disclosure relates to a method and apparatus for scheduling resources in a wireless communication system. More particularly, the present disclosure relates to a method and apparatus for scheduling resources in a wireless communication system supporting Device-to-Device (D2D) communication (hereinafter referred to as a ‘D2D communication system’).

### BACKGROUND

Recently, as a result of the prevalence of wireless devices such as smart phones, data traffic has significantly increased. The data traffic is expected to further increase, because as the number of users of wireless devices increases, more wireless device-based application services will be used. If new wireless communication between a user device and individual devices (e.g., a smart Television (TV), refrigerator, and/or the like), or a variety of wireless intelligent communications (e.g., communication between individual devices) are commercialized in addition to the typical wireless communication between users, the amount of data traffic processed in a Base Station (BS) or an evolved Node B (eNB) will increase. Existing BSs and/or eNBs may not be able to handle the increased data traffic.

Taking the surge of wireless data traffic into consideration, Device-to-Device (D2D) communication capable of direct communication between devices without the use of the eNB has been considered. The D2D communication may be used not only in the licensed frequency band in the mobile communication system, but also in the unlicensed frequency band in, for example, a Wireless Local Area Network (WLAN).

If the typical mobile communication and the D2D communication are used together, the traffic capacity of the eNB may be improved and the load of the eNB may be reduced. For example, in the mobile communication system, if User Equipments (UEs) in the same cell or adjacent cells set up a communication link (e.g., a D2D link) for D2D communication between each other, the UEs may directly exchange data with each other via the D2D link without using the eNB (or with a reduced use of the eNB). If the UEs exchange data with each other using the eNB, then two communication links (e.g., a communication link between a UE1 and the eNB and a communication link between a UE2 and the eNB) are required in mobile communication, whereas only one D2D link is required between the UE1 and the UE2 in D2D communication. Accordingly, D2D between UEs makes reduction in the number of required communication links possible.

The D2D communication may prevent the unnecessary waste of wireless resources, and may efficiently provide services by properly determining the locally generated traffic. It is important for the D2D communication to efficiently operate an operation in which a plurality of devices broadcast information about service, content, and/or the like and in which each device receives the information about the service, content, and/or the like, which is broadcasted from other devices.

In the D2D communication, unlike in the existing Ad-hoc/sensor network, after an operation of matching synchronization between devices, the discovery, pairing, and scheduling operations may be performed. In the D2D communication, each device may broadcast identification information thereof, and each device may determine identification information of other devices through the discovery. Communication connection between the devices may be performed through the pairing.

In the D2D communication, transmission/reception of data and control signals between devices, and scheduling between the devices may be performed more efficiently, compared to those in the mobile communication in which the eNB is used.

The distributed network without a master node, like the existing Ad-hoc/sensor network, is hard to make an efficient distributed protocol, whereas the D2D communication-based distributed network can make an efficient distributed protocol because devices can easily exchange control signals with each other due to the match of synchronization between the devices.

However, in the D2D communication, one device or one network node may not have the channel information of the entire network. Therefore, in the D2D communication, resource allocation is determined depending on partial information in each region in which devices are located. As a result, ensuring the maximum capacity during scheduling for resource allocation is difficult. Further, in D2D communication, overhead by control signals should be minimized.

The existing Ad-hoc/sensor network such as WiFi, ZigBee, and/or the like uses Carrier Sense Multiple Access with Collision Avoidance (CSMA-CA) which is a contention-based resource access scheme, instead of using resource allocation by scheduling. The CSMA-CA has been widely used, because if the number of UEs in the network is small, data transmission/reception may be performed avoiding the transmission during which collision may occur, without performing separate complex network management. However, the existing Ad-hoc/sensor network may decrease in user satisfaction, because the transfer rate is low in the region in which there are many users. Taking into account the surge of the number of users, there is a need for an improved scheduling method.

As regards a scheduling method for resource allocation, for example, a Time Division Multiple Access (TDMA) scheme is the resource access scheme that is most efficient when one of the devices is a master node. However, in the network in which a plurality of master nodes coexist, resource allocation between master nodes should be adjusted, causing overhead and time delay which may occur due to additional control signals for the adjustment. Therefore, the TDMA scheme is not suitable for the scalable network whose service coverage covers a large area.

In addition, FlashLinQ, which is D2D communication technology proposed by Qualcomm Inc., may modify Request To Send (RTS) and Clear To Send (CTS) control signals used in the CSMA-CA, and use the modified control signals for TDMA resource access. The FlashLinQ may experience better performance compared with the WiFi according to the related art in certain circumstances, because FlashLinQ is implemented to operate based on Orthogonal Frequency Division Multiplexing (OFDM) in the synchronous network, inspired by the previous research in which a Signal-to-Interference Ratio (SIR) is measured using RTS and CTS in the out-band of WiFi.

However, among the technologies according to the related art, the contention-based resource allocation scheme such as CSMA-CA may have excellent scalability but have low efficiency, whereas the TDMA resource allocation scheme may have excellent efficiency but have low scalability. FlashLinQ, which has been proposed to overcome such disadvantages, is designed for D2D communication, and the FlashLinQ defines slots like the TDMA scheme, for efficiency, and uses a round robin scheme for performing resource allocation in a specific order in allocating slot resources because there is no master node that manages resource allocation.

Further, the FlashLinQ may assign priority to each link, for simultaneous transmission, calculate an SIR by measuring interference from an upper link and signal power of a self link, and perform simultaneous transmission if the SIR is higher than a target threshold. Taking into account the interference to the upper link by the self link, simultaneous transmission may be performed if the SIR is higher than a target threshold.

However, FlashLinQ is technology that secures a certain number of simultaneous transmission links with a simple operation without considering the actual interference impact in the network, because FlashLinQ performs resource allocation and priority decision in a round robin way. Therefore, FlashLinQ may have lower performance, compared with the case in which the network allocates resources while the network has interference information. In addition, FlashLinQ may not have information about the interference to the upper link by other links except for the self link, because the interference to the upper link by the self link is calculated depending on the control signal transmitted by the upper link, thereby causing degradation in performance.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for efficiently performing distributed resource scheduling in a Device-to-Device (D2D) communication system.

Another aspect of the present disclosure is to provide a method and apparatus for performing distributed resource scheduling by sharing resource information in a D2D communication system.

Another aspect of the present disclosure is to provide a distributed resource scheduling method and apparatus for increasing a frequency reuse rate and the number of simultaneous transmission links in a D2D communication system.

In accordance with an aspect of the present disclosure, a distributed scheduling method in a D2D communication system is provided. The method includes transmitting, to a peer device, first resource information including a link identifier and start position information of resources to be allocated, receiving, from the peer device, second resource information in which at least one of the resource start position information and a resource allocation amount is adjusted based on the first resource information, and determining the resource start position based on the first resource information and the second resource information.

In accordance with another aspect of the present disclosure, a device for performing distributed scheduling in a D2D communication system is provided. The device includes a transceiver configured to transmit and receive a wireless signal for D2D communication, and a controller configured to control an operation of transmitting, to a peer device, first resource information including a link identifier and start position information of resources to be allocated, receiving, from the peer device, second resource information in which at least one of the resource start position information and a resource allocation amount is adjusted based on the first resource information, and determining the resource start position based on the first resource information and the second resource information.

In accordance with another aspect of the present disclosure, a distributed scheduling method in a D2D communication system is provided. The method includes receiving, from a peer device, first resource information including a link identifier and start position information of resources to be allocated, calculating a Signal-to-Interference Ratio (SIR) for each resource slot based on measured received signal power from the peer device and an adjacent device, determining an adjusted resource start position and a resource allocation amount based on the calculated SIR, and transmitting, to the peer device, second resource information including at least one of the adjusted resource start position and the resource allocation amount.

In accordance with another aspect of the present disclosure, a device for performing distributed scheduling in a D2D communication system is provided. The device includes a transceiver configured to transmit and receive a wireless signal for D2D communication, and a controller configured to control an operation of receiving, from a peer device, first resource information including a link identifier and start position information of resources to be allocated, calculating an SIR for each resource slot based on measured received signal power from the peer device and an adjacent device, determining an adjusted resource start position and a resource allocation amount based on the calculated SIR, and transmitting, to the peer device, second resource information including at least one of the adjusted resource start position and the resource allocation amount.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates devices sharing resource information for scheduling in a Device-to-Device (D2D) communication system according to an embodiment of the present disclosure;

FIG. 2 is a flowchart conceptually illustrating a distributed resource scheduling method in a D2D communication system according to an embodiment of the present disclosure;

FIGS. 3A and 3B illustrate configurations of resource information exchanged between devices according to an embodiment of the present disclosure;

FIG. 4 is a flow diagram illustrating a distributed resource scheduling method in a D2D communication system according to an embodiment of the present disclosure;

FIGS. 5A and 5B illustrate configurations of resource information exchanged between devices according to an embodiment of the present disclosure;

FIGS. 6A and 6B illustrate an example of resource allocation by first resource information transmitted from a sending device to a receiving device according to an embodiment of the present disclosure;

FIGS. 7A and 7B illustrate an example of resource allocation adjusted by second resource information transmitted from a receiving device to a sending device according to an embodiment of the present disclosure;

FIG. 8 is a flow diagram illustrating a distributed resource scheduling method in a D2D communication system according to an embodiment of the present disclosure;

FIG. 9 is a flow diagram illustrating a distributed resource scheduling method in a D2D communication system according to an embodiment of the present disclosure;

FIGS. 10A, 10B, and 10C illustrate an example of a resource allocation process that is converged when a distributed resource scheduling method is repeatedly performed according to an embodiment of the present disclosure;

FIGS. 11A, 11B, and 11C illustrate an example in which a frequency reuse rate is improved in a distributed resource scheduling method according to an embodiment of the present disclosure;

FIG. 12 is a flowchart illustrating an operation of a sending device performing distributed resource scheduling according to an embodiment of the present disclosure;

FIG. 13 is a flowchart illustrating an operation of a receiving device performing distributed resource scheduling according to an embodiment of the present disclosure;

FIGS. 14, 15, and 16 illustrate simulation results obtained by comparing performance of the scheduling method according to an embodiment of the present disclosure with performance of the FlashLinQ according to the related art; and

FIGS. 17 and 18 are flowcharts illustrating a method for determining parameter values that are needed when a peer device determines an adjusted resource allocation position and an adjusted resource allocation amount according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skilled in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

According to various embodiments of the present disclosure, a device and/or a peer device may respectively correspond to electronic devices.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

Various embodiments of the present disclosure provide a scheduling method for sharing resource information between devices to perform resource allocation, and transmitting and receiving information for resource allocation between devices to determine at least one of a resource allocation position and a resource allocation amount based on the resource information in a Device-to-Device (D2D) communication system. In addition, various embodiments of the present disclosure provide a scheduling method for repeatedly performing an operation in which in order to prevent collision of resources to be allocated between devices, adjacent devices share resource information transmitted by each device, and negotiate with each other over at least one of the position and the amount of resources to be allocated between a sending device and a receiving device, thereby to minimize the impact of interference.

A description will now be made of the concept of distributed scheduling for resource allocation, which is performed according to various embodiments of the present disclosure. Each device supporting D2D communication may transmit, to a peer device connected thereto, resource information for data transmission relating to the device. The resource information may include at least one of resource identification information indicating the start position of resources to be allocated for data transmission, and resource allocation amount information indicating the amount of resources to be allocated. The resources may be allocated in the form of, for example, time, frequency, code, space, and/or the like, and may also be allocated in units of slots. If resources are allocated in units of slots, then the resource information may include at least one of a slot index indicating the start position of slots and information about the number of slots.

According to various embodiments of the present disclosure, the resource information may be broadcasted so that not only the peer device but also adjacent other devices may receive the resource information.

FIG. 1 illustrates devices sharing resource information for scheduling in a D2D communication system according to an embodiment of the present disclosure.

Referring to FIG. 1, a plurality of devices 101, 103, 105, 111, 113 and 115 may be D2D devices that can perform direct communication with each other without the involvement of an evolved Node B (eNB) (not shown). Each device may recognize other devices through discovery because each device broadcasts identification information relating thereto. A link for communication between devices may be set up through pairing. According to various embodiments of the present disclosure, existing schemes used in D2D communication may be used for the discovery and/or pairing operations.

Each of the devices 101, 103, 105, 111, 113 and 115 may receive resource information of other devices. For example, because each of the devices 101, 103, 105, 111, 113 and 115 broadcasts own resource information for data transmission relating thereto, each of the devices 101, 103, 105, 111, 113 and 115 may receive resource information relating to the other devices. For example, it will be assumed in FIG. 1 that a link #1 11 is set up between the device 101 and the device 111, a link #2 13 is set up between the device 103 and the device 113, and a link #3 15 is set up between the device 105 and the device 115. In the example of FIG. 1, the receiving device 113 may receive resource information broadcasted from the sending device 103 to which the link #2 13 is set up, and may also receive resource information 17 and 19 respectively broadcasted from the devices 101 and 105, to which adjacent links #1 11 and #3 15 are respectively set up.

Therefore, the device 113 may share not only the resource information of a peer device thereto (e.g., peer device 103) with which the device 113 communicates, but also the resource information of adjacent other devices 101 and 105. Thus, resource allocation scheduling may be adjusted so that during resource allocation, resources in the position in which collision may occur are not allocated, and resources in the position in which collision may not occur are allocated. The device 113 may perform D2D communication by transmitting the adjusted resource information (e.g., adjusted scheduling information) to the peer device 103. The resource information may be transmitted over a separate control channel.

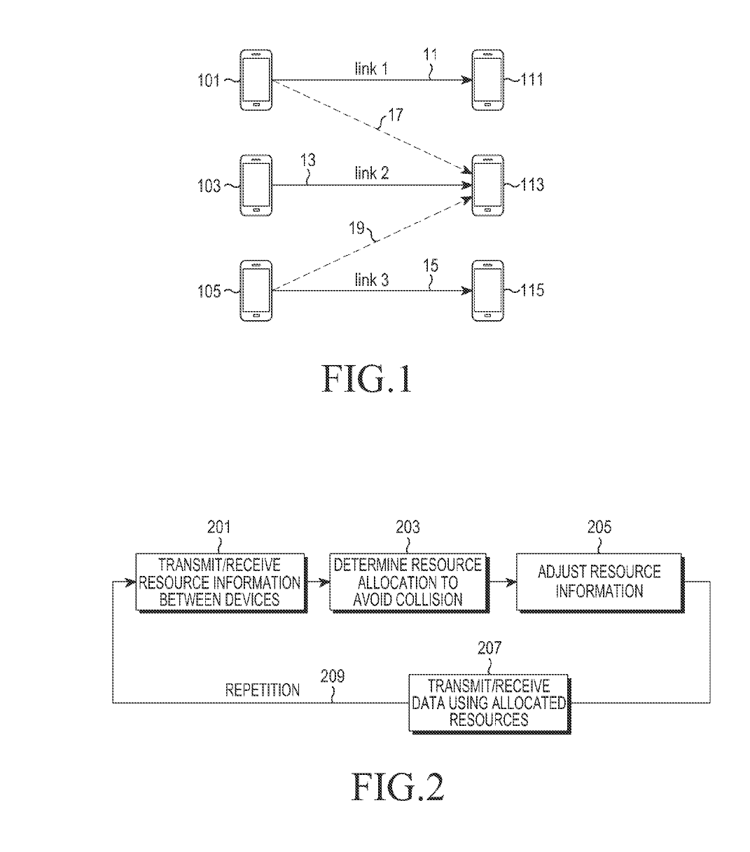

FIG. 2 is a flowchart conceptually illustrating a distributed resource scheduling method in a D2D communication system according to an embodiment of the present disclosure.

Referring to FIG. 2, at operation 201, devices desiring to perform D2D communication may broadcast resource information respectively relating thereto, and each device may receive resource information not only of a peer device thereof for D2D communication, but also of adjacent other devices.

At operation 203, each device may determine based on the received resource information whether resources of other links, which may collide with resources allocated to link of the device, and may schedule resource allocation so that collision may not occur. To this end, a receiving device that has received resource information from a sending device may transmit, to the sending device, adjusted resource information (e.g., adjusted scheduling information) obtained by adjusting at least one of the resource allocation position and the resource allocation amount, which are included in the resource information (e.g., scheduling information for resource allocation) transmitted by the sending device.

At operation 205, upon receiving the adjusted resource information, the sending device may immediately apply the adjusted resource information to the current transmission, or apply the adjusted resource information to the next transmission.

Thereafter, at operation 207, the sending device and the receiving device may transmit and receive data using the resources that are allocated depending on the resource information which are transmitted/received (or adjusted) according to the above process.

At operation 209, each device may repeat operations 201 to 207 during every resource allocation.

According to the foregoing present disclosure, a plurality of devices performing D2D communication may improve performance of D2D communication by avoiding the use of the same resources, collision of which may occur between D2D links of the plurality of devices. The performance of D2D communication may be further improved by repeatedly performing the adjustment of resource information as in the example of FIG. 2.

A detailed description will now be made of a configuration of resource information transmitted/received for scheduling of resource allocation between devices and a resource allocation scheme performed based on the resource information according to an embodiment of the present disclosure.

It will be assumed in various embodiments of the present disclosure that the D2D communication system operates based on the OFDM system, and for convenience of description, the entire frequency band used for D2D communication is separated into, for example, 64 tones, and 16 TDMA slots are used as slots for distinguishing time resources. It will be assumed that as to conditions for the experiment results, 32 or 64 TDMA slots are used. However, the above assumptions are only for the convenience of description, and for the slot, its position index may be construed as information for logically distinguishing a variety of resources such as time resources, frequency resources, code resources, space resources, and/or the like. Various embodiments of the present disclosure may be applied to any D2D communication system, in which devices share resource information indicating the allocation position and the allocation amount of various resources such as time resources, frequency resources, code resources, space resources, and/or the like, in the same way regardless of the type of resources and the type of transmission technology.

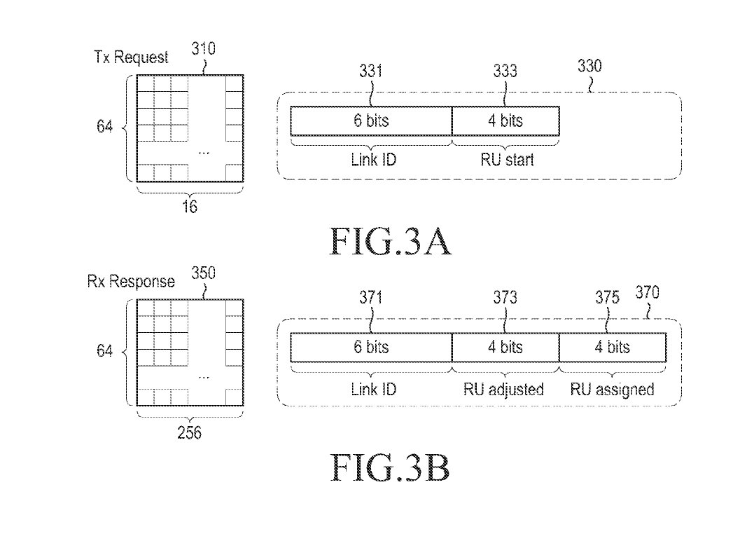

FIGS. 3A and 3B illustrate configurations of resource information exchanged between devices according to an embodiment of the present disclosure.

Referring to FIG. 3A, an example of a configuration of first resource information 330 that a sending device (not shown) transmits to a receiving device (not shown) is illustrated. Referring to FIG. 3B, an example of a configuration of second resource information 370 that after receiving the first resource information 330, the receiving device transmits to the sending device by adjusting at least one of the resource allocation position and the resource allocation amount of the first resource information 330 so that the resources of the sending device may not collide with resources allocated to other D2D links, or the link of the sending device may not interfere with other D2D links.

Referring to FIG. 3A, the first resource information 330 may include a link identifier Link_ID 331 and start position information RUₛₜₐᵣₜ 333 of resources to be allocated. The link identifier Link_ID 331 is an identifier for identifying a D2D link between a sending device and a receiving device. As an example, the Link_ID 331 may be allocated 6 bits. The start position information RUₛₜₐᵣₜ 333 of resources is an RU index indicating a start position of a Resource Unit (RU) to be allocated. As an example, the RUₛₜₐᵣₜ 333 may be allocated 4 bits.

The first resource information 330 may be included in a Transmission Request (Tx Request) message that the sending device transmits to the receiving device. As for the Tx Request message, adjacent other devices may also receive the Tx Request message, because the Tx Request message is transmitted using the common time-frequency domain. As a result, not only the receiving device, but also other devices (e.g., the adjacent other devices) may determine an index of the slot, at which each D2D link begins transmitting data.

The Tx Request message may be transmitted by being mapped to one tone-symbol in a time-frequency domain 310 (e.g., where 16*64=1024=2¹⁰ tones-symbols exist) that includes, for example, 16 time slots (or symbols) and 64 frequency tones as illustrated in FIG. 3A. Each of the 2¹⁰ tones-symbols may be defined to represent a specific bit sequence. Therefore, the start position information RUₛₜₐᵣₜ 333 of resources may mean a slot index corresponding to a slot start position of resources to be allocated to a D2D link. Because the number of time slots is 16, one of 0 to 15 may be assigned as the slot index in a circular manner. For example, if the slot start position is 14 and the amount of resources to be allocated corresponds to 4 slots, then the resources may be allocated to slot indexes 14, 15, 0 and 1.

Referring to FIG. 3B, the second resource information 370 may include a link identifier Link_ID 371, adjusted start position information RU_{adjusted} 373 of resources to be allocated, and an amount RU_{assigned} 375 of resources to be allocated. The link identifier Link_ID 371 may be the same as the link identifier Link_ID 331 in FIG. 3A. The adjusted start position information RU_{adjusted} 373 of resources to be allocated may correspond to start position information that the receiving device has obtained by adjusting the start position information RUₛₜₐᵣₜ 333 of resources in the first resource information 330. The amount RU_{assigned} 375 of resources to be allocated may mean the number of resources (e.g., the number of slots) that are to be allocated so that the resources may not collide with resources allocated to other D2D links.

The second resource information 370 may be included in a Reception Response (Rx Response) message that the sending device transmits to the receiving device in response to the Tx Request message. The Rx Response message may be transmitted by being mapped to one tone-symbol in a time-frequency domain 350 (e.g., where 256*64=16384=2¹⁶ tones-symbols exist) that includes, for example, 256 time slots (or symbols) and 64 frequency tones as illustrated in FIG. 3B. Each of the 2¹⁶ tones-symbols is defined to represent a specific bit sequence. The adjusted start position information RU_{adjusted} 373 of resources to be allocated may mean a slot index corresponding to an adjusted slot start position of resources to be allocated.

According to various embodiments of the present disclosure, the sending device and the receiving device, which perform D2D communication, may efficiently schedule resource allocation by repeatedly transmitting and receiving the first resource information and second resource information as control information for scheduling of resource allocation, during every resource allocation. As for the first resource information and second resource information, adjacent devices may also receive the first resource information and second resource information, thereby making prevention of resource collision between D2D links possible.

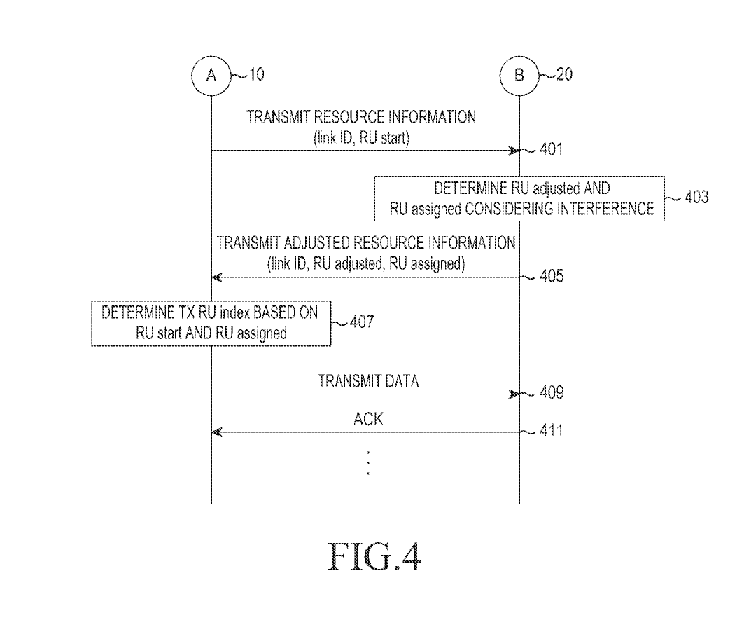

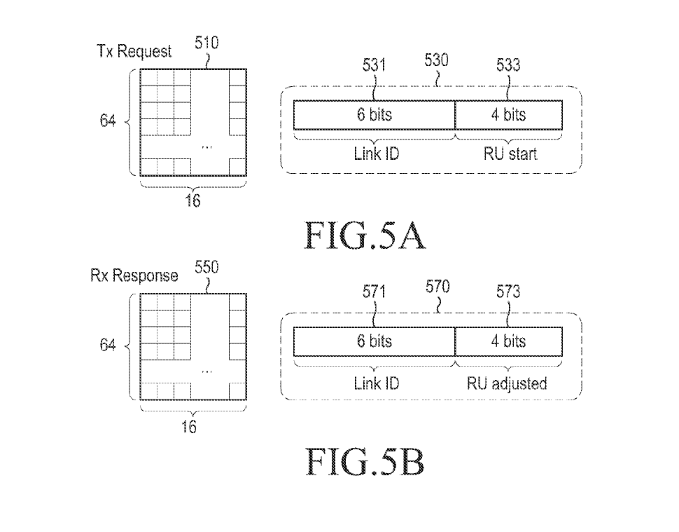

FIG. 4 is a flow diagram illustrating a distributed resource scheduling method in a D2D communication system according to an embodiment of the present disclosure.

According to various embodiments of the present disclosure, the scheduling procedure may be performed between a sending device 10 and a receiving device 20 using the first resource information and second resource information in FIGS. 3A and 3B.

Referring to FIG. 4, at operation 401, the sending device 10 may transmit the first resource information 330 using the Tx Request message described in

FIG. 3A. The first resource information 330 may include the link identifier Link_ID 331 and the start position information RUₛₜₐᵣₜ 333 of resources to be allocated.

At operation 403, the receiving device 20 may receive the Tx Request message from the sending device and obtain the first resource information 330 from the received Tx Request message. The receiving device 20 may determine based on the first resource information 330 whether other resources colliding with resources to be allocated exist in other links, and if colliding resources are determined to exist, then the receiving device 20 may determine and generate the second resource information 370 that the receiving device 20 transmits to the sending device 10, by adjusting at least one of the resource allocation position and the resource allocation amount of the first resource information 330 so that the collision may be avoided. The second resource information 370 may include the adjusted start position information RU_{adjusted} 373 of resources to be allocated, and the amount RU_{assigned} 375 of resources to be allocated.

At operation 405, the receiving device 20 may transmit the second resource information 370 to the sending device 10 using the Rx Response message described in FIG. 3B.

According to various embodiments of the present disclosure, the receiving device 20 may measure received signal power for a signal received from the sending device 10, and may also receive Tx Request messages from adjacent other devices (not shown) and measure received signal power for each of the received Tx Request messages. Links of other devices may be distinguished by link identifiers respectively associated therewith. The receiving device 20 may calculate an expected SIR for each resource slot of the D2D link based on the measured received signal power from the sending device 10 and the measured received power from the adjacent devices.

The receiving device 20 may determine that interference by other D2D links is low, if the SIR is greater than or equal to a predetermined threshold. The receiving device 20 may determine that interference by other D2D links is high, if the SIR is less than a predetermined threshold. Based on the determination results, the receiving device 20 may determine and generate the second resource information 370 obtained by adjusting the first resource information 330 taking into account the position of the slot. A detailed calculation method for determining the second resource information 370 will be described below.

An operation of determining whether to adjust resource information by measuring the SIR may increase a frequency reuse rate. For example, if frequency resources allocated in one D2D link are used even in another D2D link, then resource collision may occur. However, if the distance between the two D2D links is long enough, then interference may not occur. In this case, the frequency resources may be reused in both D2D links. Therefore, the frequency reuse rate may be increased according to various embodiments of the present disclosure in which the receiving device measures received power of a signal received from each D2D link, measures an SIR for the received power, and compares the measured SIR with a threshold to determine whether to adjust resource information. According to various embodiments of the present disclosure, the operation of measuring the SIR may be optionally performed.

Referring back to FIG. 4, at operation 407, the sending device 10 may obtain the second resource information 370 from the Rx Response message received at operation 405, and determine the start position and the amount of resources to be used in this scheduling, based on the start position information RUₛₜₐᵣₜ 333 of resources in the first resource information and the amount RU_{assigned} 375 of resources to be allocated in the second resource information. The determined resource start position may mean, for example, an index of the slot where data transmission begins. Based on the adjusted start position information RU_{adjusted} 373 of resources in the second resource information, the sending device 10 may determine the resource start position to be applied in the next scheduling. After the data transmission by the start position information RUₛₜₐᵣₜ 333 is completed, the determined start position information may be transmitted to the receiving device 20 by being included in the first resource information as resource start position information during the next scheduling.

Thereafter, at operation 409, the sending device 10 may perform data transmission beginning at the resource start position determined at operation 407.

At operation 411, the receiving device 20 may transmit an Acknowledgement (ACK) signal indicating a normal reception of the data (e.g., by the receiving device 20), to the sending device 10.

FIGS. 5A and 5B illustrate configurations of resource information exchanged between devices according to an embodiment of the present disclosure.

Referring to FIG. 5A, first resource information 530 that a sending device transmits to a receiving device may include a link identifier Link_ID 531 and start position information RUₛₜₐᵣₜ 533 of resources to be allocated. The first resource information 530 is the same as the first resource information 330 described in FIG. 3A, so a detailed description thereof will be omitted.

The first resource information 530 may be included in a Transmission Request (Tx Request) message that the sending device transmits to the receiving device. The Tx Request message may be transmitted by being mapped to one tone-symbol in a time-frequency domain 510.

Referring to FIG. 5B, an example of a configuration of second resource information 570 that the receiving device transmits to the sending device. For example, the second resource information 570 corresponds to resource information that after receiving the first resource information 530, the receiving device transmits to the sending device by adjusting at least one of the resource allocation position and the resource allocation amount of the first resource information 530 so that resources of the sending device may not collide with resources allocated to other D2D links, or the link of the sending device may not interfere with other D2D links. The second resource information 570 may include a link identifier Link_ID 571 and adjusted start position information RU_{adjusted} 573 of resources to be allocated. In contrast, to the second resource information 370 in FIG. 3B, the second resource information 570 may not include the amount RU_{assigned} of resources to be allocated.

The link identifier Link_ID 571 and the adjusted start position information RU_{adjusted} 573 of resources to be allocated are the same as those in FIG. 3B, a detailed description thereof will be omitted. The second resource information 570 may be included in an Rx Response message that the sending device transmits to the receiving device in response to the Tx Request message, and it will be assumed that the Rx Response message is transmitted in a time-frequency domain 550 that includes 16 time slots (or symbols) and 64 frequency tones as in FIG. 5B.

Referring to FIG. 5B, the receiving device may transmit bit information (e.g., a More RU bit) indicating the end of resource allocation to the sending device in every slot so that the sending device may recognize slots corresponding to the amount of resources to be allocated, instead of excluding the amount RU_{assigned} of resources to be allocated, from the second resource information 570. For example, if the next slot is allocated when the receiving device transmits an ACK signal for the received data with respect to every slot transmission, then the receiving device may set the More RU bit as ‘1’ and transmit the More RU bit to the sending device, and if the next slot is not allocated, then the receiving device may set the More RU bit as ‘0’ and transmit the More RU bit to the sending device. Therefore, the sending device may determine based on the More RU bit whether to allocate resources for data transmission in the next slot, even though there is no transmission of information about the amount RU_{assigned} of resources from the receiving device. If the More RU bit is set as ‘0’, then the sending device may stop the data transmission in the next slot.

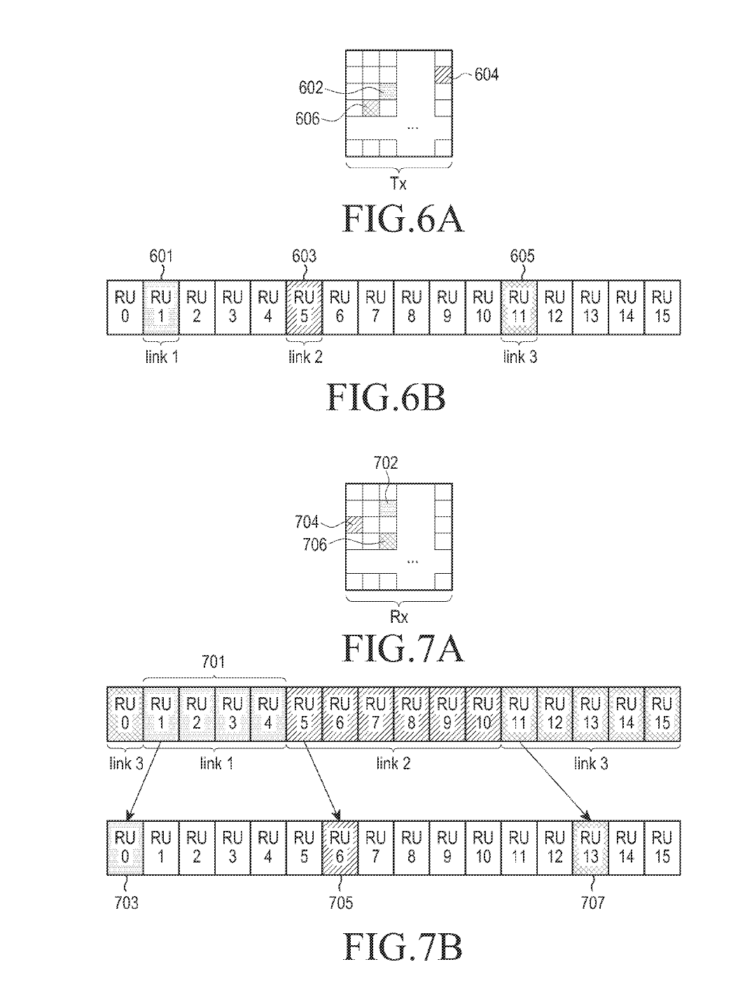

FIGS. 6A and 6B illustrate an example of resource allocation by first resource information transmitted from a sending device to a receiving device according to an embodiment of the present disclosure.

Referring to FIG. 6A, a Tx Request message including the first resource information 530 may be transmitted in each D2D link through a different tone-symbol in the time-frequency domain. For example, FIG. 6A illustrates the time-frequency domain including a resource allocation associated with Tx Request message 602 corresponding to link 1, a resource allocation associated with Tx Request message 604 corresponding to link 2, and a resource allocation associated with Tx Request message 606 corresponding to link 3.

Referring to FIG. 6B, assuming that the number of time slots is 16, reference numerals 601, 603, and 605 represent an RU index (e.g., a slot index) corresponding to the start position information RUₛₜₐᵣₜ 533 of resources in a link 1, a link 2 and a link 3 distinguished by the link identifier 531 in the first resource information 530, respectively.

FIGS. 7A and 7B illustrate an example of resource allocation adjusted by second resource information transmitted from a receiving device to a sending device according to an embodiment of the present disclosure.

Referring to FIG. 7A, in each D2D link, an Rx Response message including the second resource information 570 may be transmitted through a different tone-symbol in the time-frequency domain. For example, FIG. 6A illustrates the time-frequency domain including a resource allocation associated with Rx Response message 702 corresponding to link 1, a resource allocation associated with Rx Response message 704 corresponding to link 2, and a resource allocation associated with Rx Response message 706 corresponding to link 3.

Referring to FIG. 7B, assuming that the number of time slots is 16, four slots 701 are allocated to a link 1 and six slots are allocated to each of a link 2 and a link 3 in the RU index (e.g., slot index) corresponding to the start position information RUₛₜₐᵣₜ 533 in FIG. 5A. In FIG. 7B, reference numerals 703, 705 and 707 each represent an example of resource allocation by the second resource information 570 obtained by adjusting the resource allocation position and the resource allocation amount so that the resources may not collide with resources allocated to other D2D links, or the link may not interfere with other D2D links in the receiving device in the link 1, the link 2 and the link 3.

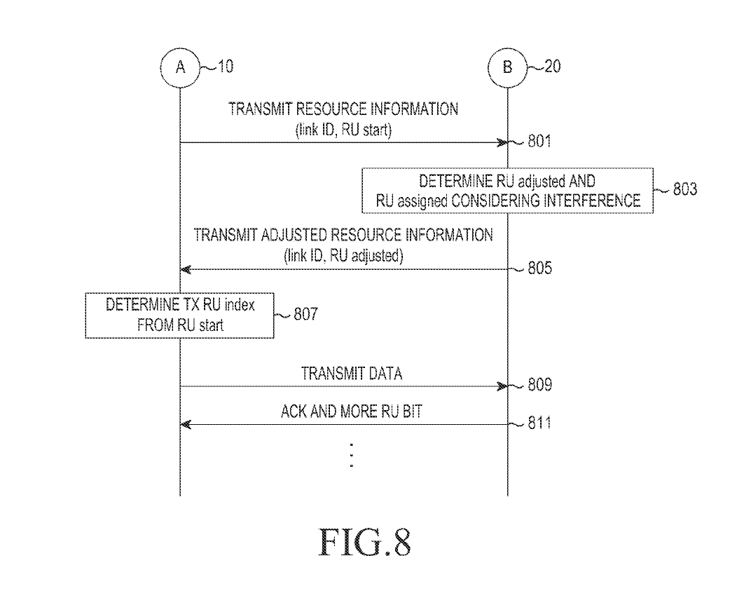

FIG. 8 is a flow diagram illustrating a distributed resource scheduling method in a D2D communication system according to another embodiment of the present disclosure.

According to various embodiments of the present disclosure, the distributed resource scheduling procedure may be performed between a sending device 10 and a receiving device 20 using the first resource information and second resource information in FIGS. 5A and 5B.

Referring to FIG. 8, at operation 801 the sending device 10 transmits a Tx Request message including first resource information to the receiving device 20.

At operation 803, the receiving device 20 determines an adjusted resource allocation position RU_{adjusted} and an adjusted resource allocation amount RU_{assigned} based on the first resource information.

Operations 801 and 803 may be the same as operations 401 and 403 in FIG. 4.

At operation 805, the receiving device 20 may transmit, to the sending device 10, an Rx Response message including second resource information 570 that includes the link identifier Link_ID 571 and the adjusted start position information RU_{adjusted} 573 of resources to be allocated, excluding the amount RU_{assigned} of resources to be allocated, as described in FIG. 5B. According to the various embodiments of the present disclosure, the overhead of the Rx Response message may be reduced. Even in the example of FIG. 8, the operation, in which the receiving device 20 measures received power of a signal received from each D2D link, measures an SIR thereof, and compares the measured SIR with a threshold to determine whether to adjust resource information, may be optionally performed as in the example of FIG. 4.

At operation 807, the sending device 10 determines the start position and the amount of resources to be used in the scheduling.

At operation 809, the sending device performs data transmission.

Operations 807 and 809 may be the same as operations 407 and 409 in FIG. 4.

At operation 811, the receiving device 20 may transmit a More RU bit described in FIG. 5B to the sending device 10 together with an ACK signal indicating a normal reception of the data (e.g., by the receiving device 20), to inform whether to allocate resources for data transmission in the next slot.

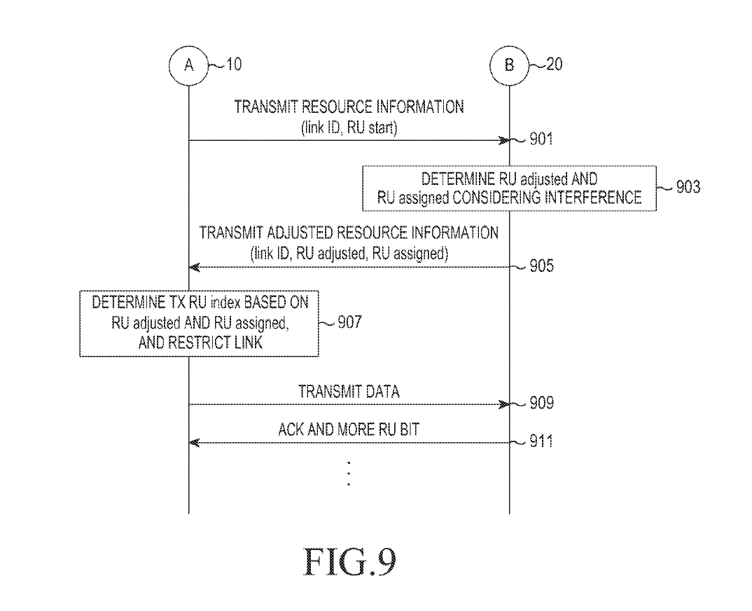

FIG. 9 is a flow diagram illustrating a distributed resource scheduling method in a D2D communication system according to another embodiment of the present disclosure.

According to various embodiments of the present disclosure, the distributed resource scheduling procedure may be performed between a sending device 10 and a receiving device 20 using the first resource information and second resource information in FIGS. 5A and 5B.

Operations 901 to 911 in FIG. 9 may be the same as operations 401 to 411 in FIG. 4 except that at operation 907, the sending device 10 determines the start position and the amount of resources to be used in this scheduling based on the resource allocation position RU_{adjusted} and resource allocation amount RU_{assigned} adjusted by the receiving device 20, and performs a link restriction operation. According to various embodiments of the present disclosure, the link restriction operation may restrict some of a plurality of links desiring to use specific resources RU in order to solve the congestion in the network. The link restriction operation may include three operations of RU Reduction, Yielding, and Discard, each of which is defined as follows and is performed under the assumption that each device shares resource information of other links.

1) RU Reduction

In a case in which only one smallest RU is allocated by controlling the number of RUs allocated for D2D communication, if there is another link allocated redundantly, transmission is abandoned at a probability of 50%.

2) Yielding

In a case in which priority is given to a link identifier in every resource allocation, if an SIR by interference, which is measured by calculating interference for a high-priority link, is less than a threshold, transmission is yielded.

3) Discard

In a case in which priority is given to a link identifier in every resource allocation, a receiving device with the top-priority link calculates interference, and transmits a transmission abandon command to a sending device having the lowest-priority link which acts as a cause of interference.

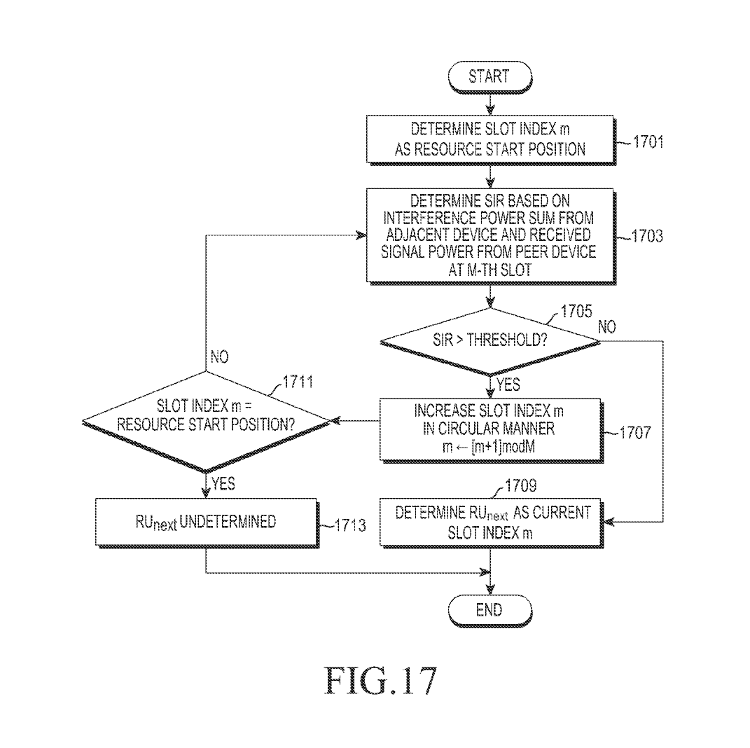

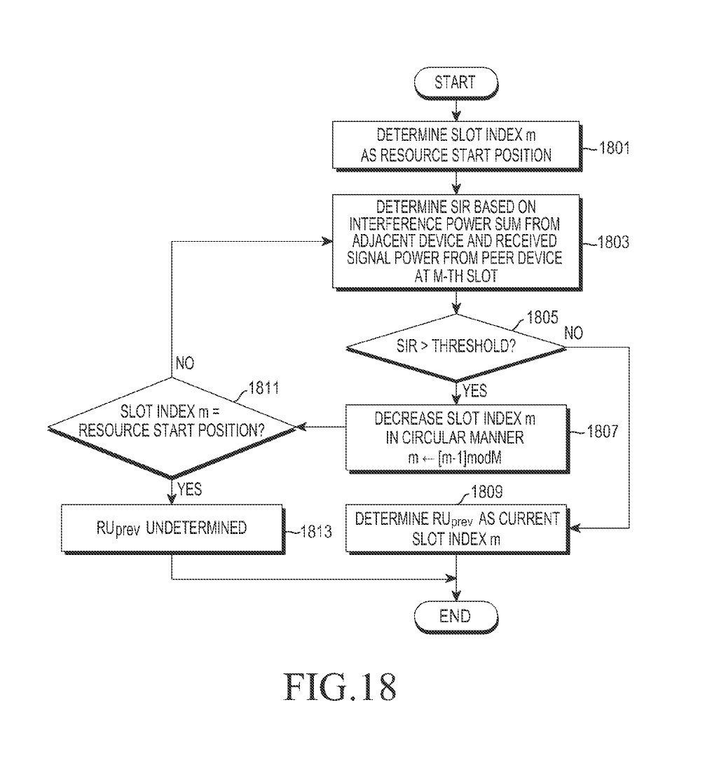

According the various embodiments of the present disclosure, which have been described in FIGS. 4, 8 and 9, the receiving device may first perform the process of determining RUₙₑₓₜ and RUₚᵣₑᵥ, when determining the adjusted resource allocation position RU_{adjusted} and resource allocation amount RU_{assigned}. RUₙₑₓₜ may be determined by the process illustrated in FIG. 17, and RUₚᵣₑᵥ may be determined by the process illustrated in FIG. 18.

FIGS. 17 and 18 are flowcharts illustrating a method for determining parameter values that are needed when a receiving device determines an adjusted resource allocation position and an adjusted resource allocation amount according to an embodiment of the present disclosure.

According to various embodiments of the present disclosure, the parameter values correspond to RUₙₑₓₜ and RUₚᵣₑᵥ in Tables 1 and 2 below.

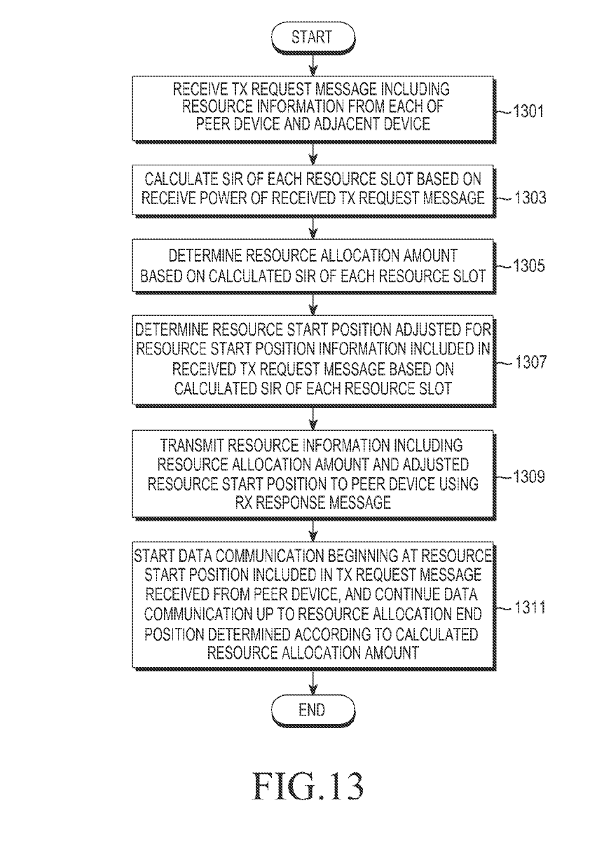

Referring to FIG. 17, at operation 1701, the receiving device may determine a slot index ‘m’ as a resource start position in resource information of a Tx Request message received at operation 1301 in FIG. 13 that illustrates an operation of the receiving device according to an embodiment of the present disclosure.

At operation 1703, the receiving device may calculate an SIR in an m-th resource slot based on the sum of received signal power from the peer device and interference power from an adjacent device.

At operation 1705, the receiving device may determine whether the SIR in the m-th slot, which is determined at operation 1703, is greater than a predetermined threshold.

If the receiving device determines that the SIR is greater than the threshold at operation 1705, then the receiving device may proceed to operation 1707 at which the receiving device may increase the current slot index ‘m’ by one. If the slot index ‘m’ is greater than the total number M of slots, then the receiving device may determine the next slot index by performing a modulo-M operation on the increased value of m+1 so that the receiving device may specify the slot index within an available slot range. Thereafter, the receiving device may proceed to operation 1711.

At operation 1711, the receiving device may determine whether the slot index increased at operation 1707 is the same again as the initial resource start position determined at operation 1701.

If the receiving device determines that the slot index is not the same as the initial resource start (e.g., determined at operation 1701) at operation 1711, then the receiving device may go back to operation 1703 and repeat its succeeding operations.

However, if the receiving device determines that the slot index determines that the slot index increased at operation 1707 is the same again as the initial resource start position (e.g., determined at operation 1701) at operation 1711, then the receiving device may proceed to operation 1713 at which the receiving device may determine that RUₙₑₓₜ is not determined in the scheduling.

In contrast, if the receiving device determines that the SIR in the slot index ‘m’ is less than the threshold at operation 1705, then the receiving device may proceed to operation 1709 at which the receiving device may determine RUₙₑₓₜ as the current slot index ‘m’.

Referring to FIG. 18, at operation 1801, the receiving device may determine a slot index ‘m’ as a resource start position in resource information of a Tx Request message received at operation 1301 in FIG. 13 that illustrates an operation of the receiving device according to an embodiment of the present disclosure.

At operation 1803, the receiving device may calculate an SIR in an m-th resource slot based on the sum of received signal power from the peer device and interference power from an adjacent device.

At operation 1805, the receiving device may determine whether the SIR in the m-th slot, which is determined at operation 1803, is greater than a predetermined threshold.

If the receiving device determines that the SIR is greater than the threshold at operation 1805, then the receiving device may proceed to operation 1805 at which the receiving device may decrease the current slot index ‘m’ by one. If the slot index ‘m’ is less than zero (0), then the receiving device may determine the next slot index by performing a modulo-M operation on the decreased value of m−1 so that the receiving device may specify the slot index within an available slot range. Thereafter, the receiving device may proceed to operation 1811.

At operation 1811, the receiving device may determine whether the slot index decreased at operation 1807 is the same again as the initial resource start position determined at operation 1801.

If the receiving device determines that the slot index is not the same again as the initial resource start position at operation 1811, then the receiving device may go back to operation 1803 and repeat its succeeding operations.

However, if the receiving device determines that the slot index is the same again as the initial resource start position at operation 1811, then the receiving device may proceed to operation 1813 at which the receiving device may determine that RUₚᵣₑᵥ is not determined in the scheduling.

In contrast, if the receiving device determines that the SIR in the slot index ‘m’ is less than the threshold at operation 1805, then the receiving device may proceed to operation 1809 at which the receiving device may finally determine RUₚᵣₑᵥ as the current slot index ‘m’.

According to the various embodiments of the present disclosure, which have been described in FIGS. 4, 8, 9 and 13, the resource allocation amount RU_{assigned} may be calculated using Table 1 below, and values of RUₙₑₓₜ and RUₚᵣₑᵥ may be determined by the methods described in FIGS. 17 and 18.

TABLE 1

| Decision conditions | | |
|---|---|---|
| RUₙₑₓₜ determined | RUₚᵣₑᵥ determined | RU_{assigned} |
| Yes | Yes | [RUₙₑₓₜ − RUₛₜₐᵣₜ] mod M |
| No | Yes | [RUₚᵣₑ − RUₛₜₐᵣₜ] mod M |
| Yes | No | [RUₙₑₓₜ − RUₛₜₐᵣₜ] mod M |
| No | No | M |

According to various embodiments of the present disclosure, the adjusted resource allocation position RU_{adjusted} may be calculated using Table 2 below and Equations (1) and (2) below, and values of RUₙₑₓₜ and RUₚᵣₑᵥ may be determined by the methods described in FIGS. 17 and 18.

TABLE 2

| Decision conditions | | |
|---|---|---|
| RUₙₑₓₜ determined | RUₚᵣₑᵥ determined | RU_{adjusted} |
| Yes | Yes | [RUₛₜₐᵣₜ + 0.5 × (RU_{gap}_{_{—}}ₙₑₓₜ − |
| | | RU_{gap}_{_{—}}ₚᵣₑᵥ)] mod M |
| No | Yes | [RUₛₜₐᵣₜ + 0.5 × (M − 2 × |
| | | RU_{gap}_{_{—}}ₚᵣₑᵥ)] mod M |
| Yes | No | [RUₛₜₐᵣₜ + 0.5 × (2 × |
| | | RU_{gap}_{_{—}}ₙₑₓₜ − M] mod M |
| No | No | RUₛₜₐᵣₜ |

In Table 2, RU_{gap}_{_{—}}ₙₑₓₜ and RU_{gap}_{_{—}}ₚᵣₑᵥ may be calculated using Equation (1).

RU_{gap}_{_{—}}ₙₑₓₜ=[RUₙₑₓₜ−RUₛₜₐᵣₜ] mod M

RU_{gap}_{_{—}}ₚᵣₑᵥ=[RUₛₜₐᵣₜ−RU_{prev]} mod M Equation (1)

RU_{adjusted}=[(1−α)×RUₛₜₐᵣₜ+α×RU_{dest}] mod M Equation (2)

In Equation (2), α has a value between 0 and 1, and is used to adjust the degree of the adjustment when adjusting the resource start position RUₛₜₐᵣₜ to an adjusted resource start position RU_{adjusted}. If this value is large, then the degree of the adjustment is large, and if this value is small, then the degree of the adjustment is small.

According to various embodiments of the present disclosure, the receiving device may calculate an SIR for each link based on the link identifier, the resource start position information RUₛₜₐᵣₜ in the current scheduling, and the received power of each link, all of which are obtained from resource information included in a Tx Request message transmitted by the sending device. Based on the calculation results, the receiving device may calculate and determine the amount RU_{assigned} of resources to be allocated, and the resource allocation position RU_{adjusted} indicating the resource start position information RUₛₜₐᵣₜ for the next scheduling.

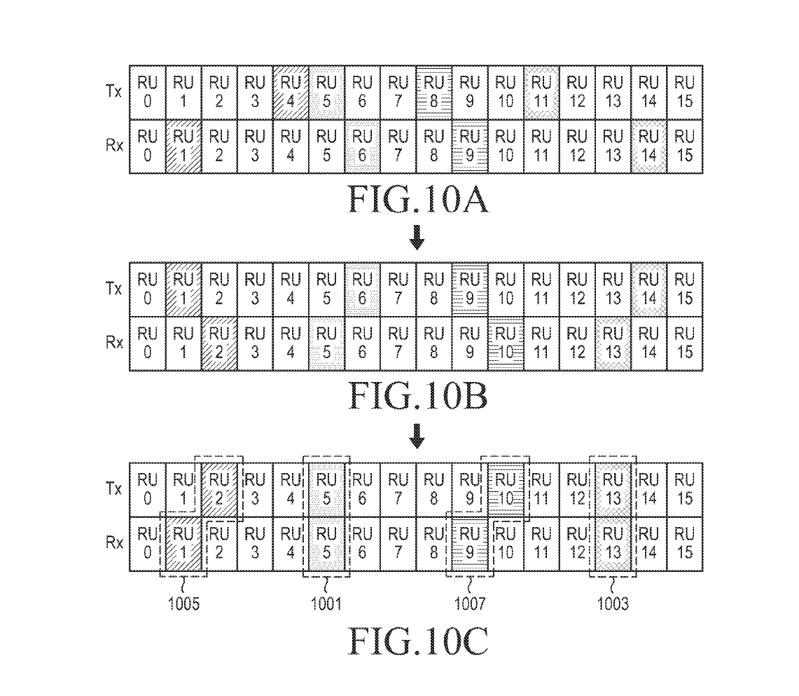

FIGS. 10A, 10B, and 10C illustrate an example of a resource allocation process that is converged when a distributed resource scheduling method is repeatedly performed according to an embodiment of the present disclosure.

Referring FIGS. 10A, 10B, and 10C, RU indexes (e.g., slot indexes) have a circular allocation structure, and RU indexes of resource start positions RUₛₜₐᵣₜ between D2D links are separately illustrated in a shaded way. If the proposed scheduling operation is repeatedly performed, then a total of 16 slots may be converged in units of four slots in each link in the start position RUₛₜₐᵣₜ as shown by reference numerals 1001, 1003, 1005 and 1007 in FIG. 10C.

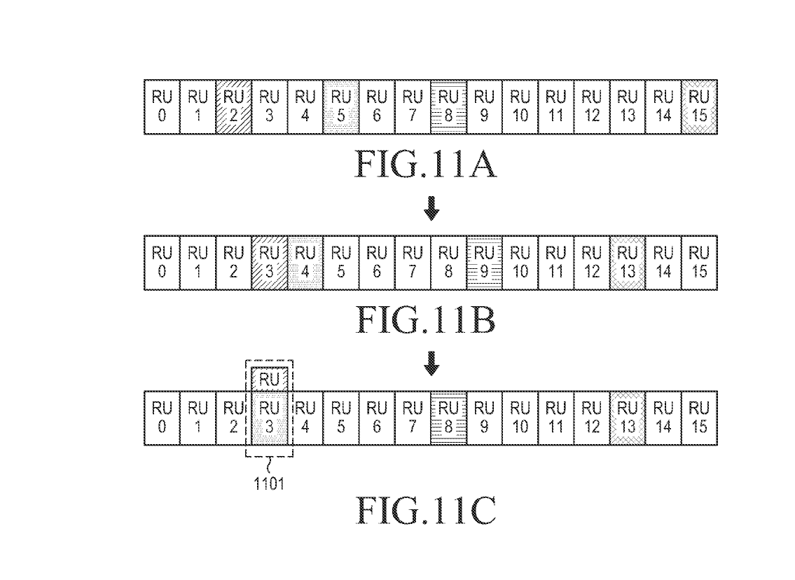

FIGS. 11A, 11B, and 11C illustrate an example in which a frequency reuse rate is improved in a distributed resource scheduling method according to an embodiment of the present disclosure.

FIGS. 11A, 11B, and 11C illustrate an example in which the resource allocation position RU_{adjusted} and the resource allocation amount RU_{assigned} are adjusted according to the repeated execution of the distributed scheduling. If an SIR for an adjacent link is greater than a threshold as a result of the scheduling, then there is no interference between a specific link and the adjacent link. In this case, as shown by reference numeral 1101, as to, for example, a slot #3 to a slot #7, even though two links share resources, there is no interference between the two links. In this case, if the two links are defined as a link 1 and a link 2, then a sending device with the link 1 and a receiving device with the link 2 may be located at a large distance from each other so that no interference may occur therebetween, and a receiving device with the link 1 and a sending device with the link 2 may also be located at a large distance from each other so that no interference may occur therebetween. Therefore, according to various embodiments of the present disclosure, the frequency reuse rate may be improved and the number of simultaneous transmission links may be maximized in the D2D network. It is preferable to calculate a sum of interferences caused by the resources redundantly used between links, and reflect the sum in resource allocation scheduling.

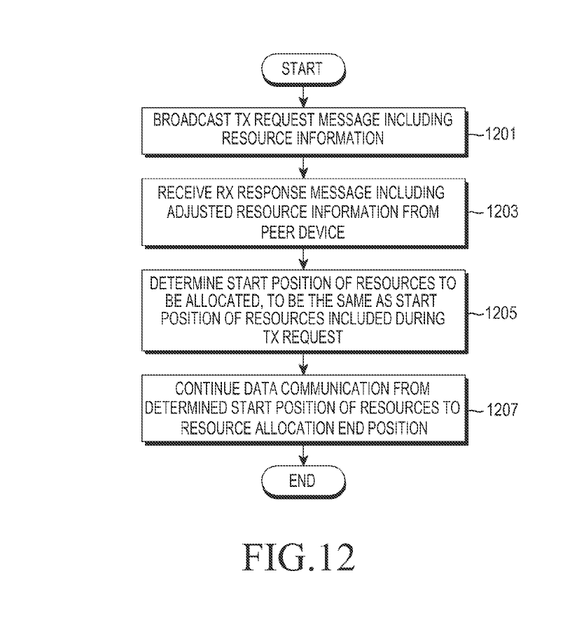

Reference will now be made to FIGS. 12 and 13, to describe operations of a sending device and a receiving device according to various embodiment of the present disclosure, respectively. As for operations in FIGS. 12 and 13, the example of FIG. 8 is reflected therein.

FIG. 12 is a flowchart illustrating an operation of a sending device performing distributed resource scheduling according to an embodiment of the present disclosure.

Referring to FIG. 12, at operation 1201, the sending device may broadcast a Tx Request message including resource information relating thereto.

At operation 1203, the sending device may receive an Rx Response message including adjusted resource information from its peer device (or a receiving device).

Thereafter, at operation 1205, the sending device may determine the resource start position to be the same as the resource start position which was included when transmitting the Tx Request message at operation 1201.

At operation 1207, the sending device may continue the data communication beginning at the determined resource start position until the sending device receives resource allocation end information (e.g., More RU bit=‘0’) from the peer device (or the receiving device). Although not illustrated in FIG. 12, the sending device may receive a More RU bit of ‘1’ in every slot while the data communication continues.

As another example, at operation 1207 of FIG. 12, the sending device may continue the data communication beginning at the resource start position determined at operation 1205 up to the resource allocation end position that is determined based on the resource allocation amount in the adjusted resource information received from the peer device.

FIG. 13 is a flowchart illustrating an operation of a receiving device performing distributed resource scheduling according to an embodiment of the present disclosure.

Referring to FIG. 13, at operation 1301, the receiving device may receive a Tx Request message including resource information from each peer device thereto and an adjacent device(s). The peer device and the adjacent device may be distinguished using a link identifier included in the Tx Request message.

At operation 1303, the receiving device may calculate an SIR for each slot based on the received power of the Tx Request message received at operation 1301.

At operation 1305, the receiving device may determine the resource allocation amount based on the SIR for each resource slot, which is calculated at operation 1303. According to various embodiments of the present disclosure, an operation of allocating resources may begin at the resource start position just before the resource slot position at which the SIR is lower than a threshold, under the assumption that resource slots are continuously allocated.

At operation 1307, the receiving device may adjust the resource start position to be reflected during the next scheduling, for the resource start position information included in the Tx Request message received at operation 1301, based on the SIR for each resource slot, which is calculated at operation 1303, and determine the results as an adjusted resource start position.

Thereafter, at operation 1309, the receiving device may transmit resource information including the resource allocation amount determined at operation 1305 and the adjusted resource start position determined at operation 1307, using an Rx Response message. After completion of the process of exchanging control signals for scheduling at operations 1301 to 1309, the receiving device may proceed to operation 1311 for data transmission/reception.

At operation 1311, the receiving device may start data communication beginning at the resource start position included in the Tx Request message that is received from the peer device at operation 1301, and continue the data communication up to the resource allocation end position determined depending on the resource allocation amount that is calculated at operation 1305. At operation 1311, the receiving device may determine a More RU bit depending on the end/non-end of each slot, and send the More RU bit to the peer device.

According to various embodiments of the present disclosure, the D2D network may share resource information between devices in a distributed way without the centralized control by, for example, a master node, and schedule resource allocation. Therefore, the frequency reuse rate may be improved and the number of simultaneous transmission links may be maximized, so that the transmission capacity of the D2D network may be locally maximized.

Furthermore, in accordance with another aspect of the present disclosure, a sending device and a receiving device may transmit control including TX Request and RX Response, or data using the allocated resources (or resource blocks) in either a contention-free manner or a contention-based manner. In this case, the contention-based manner such as Carrier Sense Multiple Access with Collision Avoidance (CSMA-CA) may be used to avoid interferences from different system.

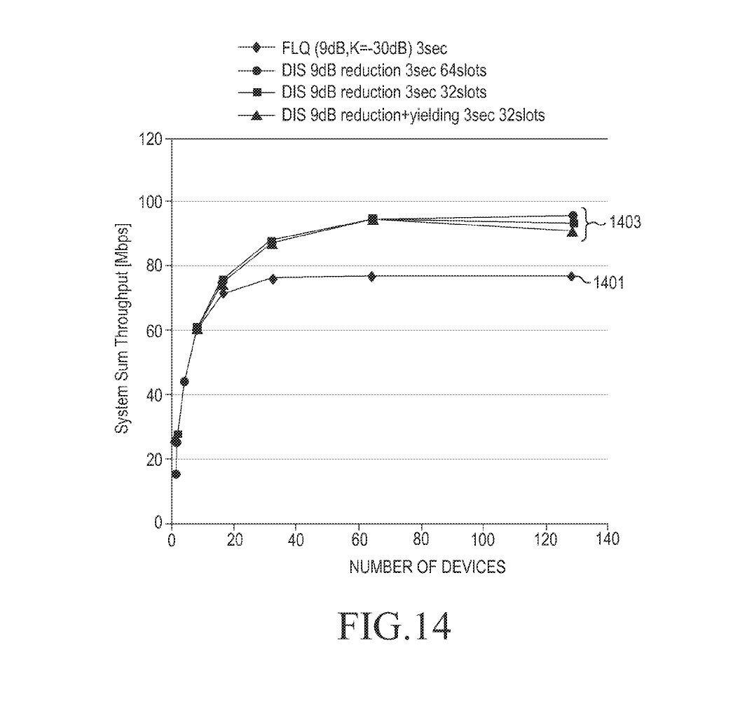

FIGS. 14, 15, and 16 illustrate simulation results obtained by comparing performance of the scheduling method according to an embodiment of the present disclosure with performance of the FlashLinQ according to the related art.

Referring to FIG. 14, reference numeral 1401 represents the throughput by FlashLinQ, and reference numeral 1403 represents the throughput by the scheduling method according to an embodiment of the present disclosure on the conditions described on the top of the drawing. It can be appreciated from the simulation results in FIG. 14 that the scheduling method according to an embodiment of the present disclosure shows improvement of 20% in terms of the throughput, compared with the FlashLinQ according to the related art.

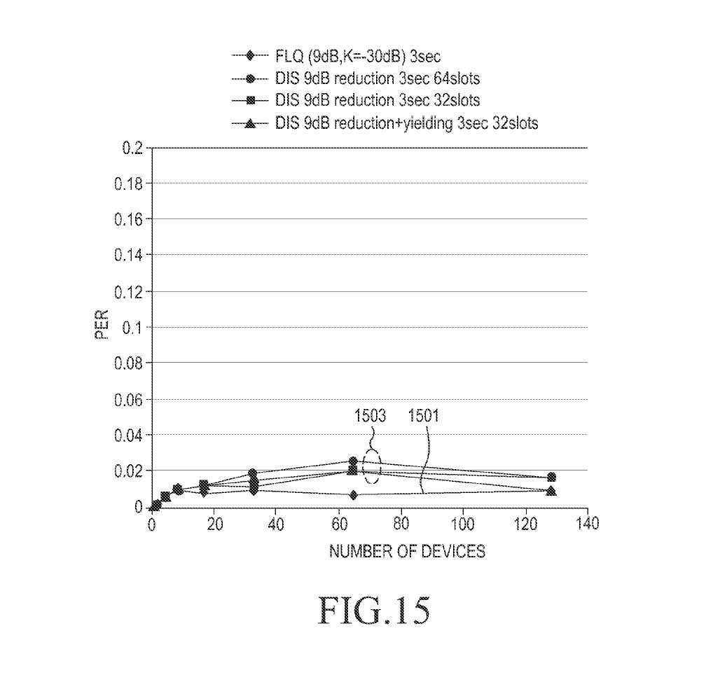

Referring to FIG. 15, the simulation results obtained by comparing the scheduling method according to an embodiment of the present disclosure with the FlashLinQ according to the related art in terms of a Packet Error Rate (PER). Reference numeral 1501 represents the PER performance of a scheduling method using FlashLinQ according to the related art. Reference numeral 1503 represents the PER performance of an embodiment of the present disclosure. The PER performance of an embodiment of the present disclosure the present disclosure is somewhat high (e.g., in relation to the PER performance using FlasLinQ according to the related art). However, the PER performance of an embodiment of the present disclosure is sufficiently acceptable in the system.

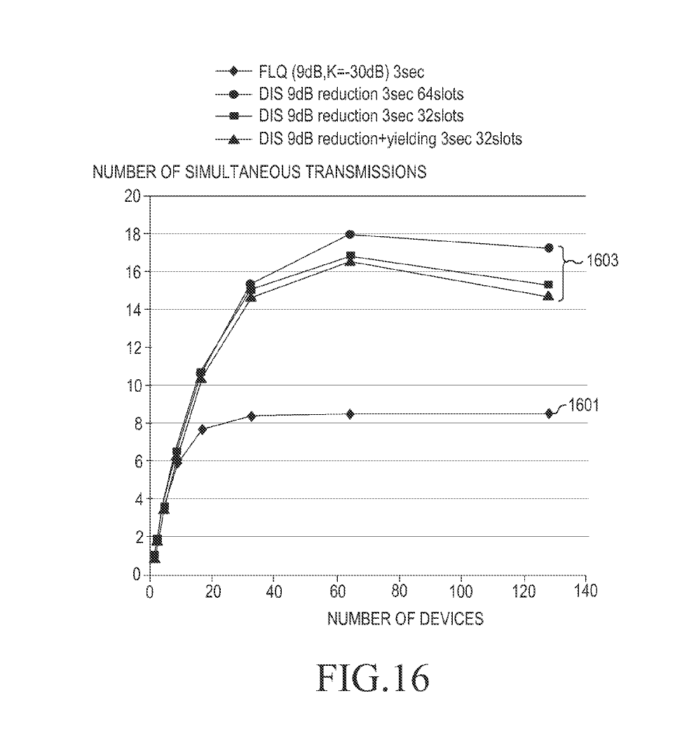

Referring to FIG. 16 shows the simulation results obtained by comparing the scheduling method according to an embodiment of the present disclosure with the FlashLinQ according to the related art in terms of the number of simultaneous transmissions. It can be appreciated that the number of simultaneous transmissions remarkably increases when the proposed scheduling method is applied. Reference numeral 1501 represents the number of simultaneous transmissions of a scheduling method using FlashLinQ according to the related art. Reference numeral 1503 represents the number of simultaneous transmissions of an embodiment of the present disclosure.

Although not illustrated, according to various embodiments of the present disclosure, a sending device and a receiving device each may include a transceiver for D2D communication, and a controller for exchanging resource information with the peer device in accordance with the scheduling method described the examples of, for example, FIGS. 4, 8 and 9, and controlling D2D communication depending on the resource information.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A distributed scheduling method in a Device-to-Device (D2D) communication system, the distributed scheduling method comprising:
transmitting, to a peer device, first resource information including a link identifier and start position information of resources to be allocated;
receiving, from the peer device, second resource information in which at least one of the resource start position information and a resource allocation amount is adjusted based on the first resource information; and
determining the resource start position based on the first resource information and the second resource information.

2. The method of claim 1, wherein the first resource information and the second resource information are broadcasted over common resources.

3. The method of claim 1, wherein the second resource information includes the link identifier and the resource start position information that is adjusted by the peer device.

4. The method of claim 1, wherein the second resource information includes the link identifier, the resource start position information that is adjusted by the peer device, and the resource allocation amount information.

5. The method of claim 1, further comprising:
performing data transmission from the resource start position up to a resource position corresponding to the resource allocation amount; and
receiving, from the peer device, an acknowledgement signal for the data transmission and information indicating whether to allocate next resources.

6. The method of claim 1, further comprising:
if the second resource information includes the adjusted resource start position information, transmitting the first resource information including the adjusted start position information to the peer device during next scheduling.

7. The method of claim 1, further comprising:
receiving, from the peer device, information indicating whether to allocate next resources; and
determining whether to allocate the next resources based at least in part on the information indicating whether to allocate the next resources.

8. The method of claim 7, wherein the information indicating whether to allocate the next resources corresponds to a bit that is toggled to indicate whether to stop data transmission in a next slot.

9. The method of claim 1, wherein data transmission using the method of claim 1 is performed in either a contention-free manner or a contention-based manner.

10. The method of claim 9, wherein the contention-based manner denotes Carrier Sense Multiple Access with Collision Avoidance (CSMA-CA).

11. A non-transitory computer-readable storage medium storing instructions that, when executed, cause at least one processor to perform the method of claim 1.

12. A device for performing distributed scheduling in a Device-to-Device (D2D) communication system, the device comprising:
a transceiver configured to transmit and receive a wireless signal for D2D communication; and
a controller configured to control an operation of transmitting, to a peer device, first resource information including a link identifier and start position information of resources to be allocated, receiving, from the peer device, second resource information in which at least one of the resource start position information and a resource allocation amount is adjusted based on the first resource information, and determining the resource start position based on the first resource information and the second resource information.

13. The device of claim 12, wherein the first resource information and the second resource information are broadcasted over common resources.

14. The device of claim 12, wherein the second resource information includes the link identifier and the resource start position information that is adjusted by the peer device.

15. The device of claim 12, wherein the second resource information includes the link identifier, the resource start position information that is adjusted by the peer device, and the resource allocation amount information.

16. The device of claim 12, wherein the controller is configured to control an operation of performing data transmission from the resource start position up to a resource position corresponding to the resource allocation amount, and receiving, from the peer device, an acknowledgement signal for the data transmission and information indicating whether to allocate next resources.

17. The device of claim 12, wherein the controller is configured to control an operation of, if the second resource information includes the adjusted resource start position information, transmitting the first resource information including the adjusted start position information to the peer device during next scheduling.

18. The device of claim 12, wherein the controller is configured to control an operation of receiving, from the peer device, information indicating whether to allocate next resources, and determining whether to allocate the next resources based at least in part on the information indicating whether to allocate the next resources.

19. The device of claim 12, wherein the information indicating whether to allocate the next resources corresponds to a bit that is toggled to indicate whether to stop data transmission in a next slot.

20. The device of claim 12, wherein data transmission using the device of claim 1 is performed in either contention-free manner or contention-based manner.

21. The device of claim 20, wherein the contention-based manner denotes Carrier Sense Multiple Access with Collision Avoidance (CSMA-CA).

22. A distributed scheduling method in a Device-to-Device (D2D) communication system, the distributed scheduling method comprising:
receiving, from a peer device, first resource information including a link identifier and start position information of resources to be allocated;
calculating a Signal-to-Interference Ratio (SIR) for each resource slot based on measured received signal power from the peer device and an adjacent device;
determining an adjusted resource start position and a resource allocation amount based on the calculated SIR; and
transmitting, to the peer device, second resource information including at least one of the adjusted resource start position and the resource allocation amount.

23. The method of claim 22, wherein the adjusted resource start position and the resource allocation amount are determined to prevent collision with another D2D link.

24. The method of claim 22, wherein the determining comprises:
measuring received power of a signal received from each D2D link;
measuring the SIR; and
comparing the measured SIR with a preset threshold to determine whether to adjust resource information.

25. The method of claim 22, wherein the determining comprises:
determining that interference by another D2D link is low, if the SIR is greater than or equal to a preset threshold; and
determining that interference by another D2D link is high, if the SIR is less than the preset threshold; and
generating, if the interference is high, the second resource information that is obtained by adjusting the first resource information considering a position of a slot.

26. The method of claim 22, further comprising:
transmitting, to the peer device, bit information indicating whether to terminate the resource allocation in every slot.

27. The method of claim 22, wherein data transmission using the method of claim 22 is performed in either a contention-free manner or a contention-based manner.

28. The method of claim 27, wherein the contention-based manner denotes Carrier Sense Multiple Access with Collision Avoidance (CSMA-CA).

29. A non-transitory computer-readable storage medium storing instructions that, when executed, cause at least one processor to perform the method of claim 22.

30. A device for performing distributed scheduling in a Device-to-Device (D2D) communication system, the device comprising:
a transceiver configured to transmit and receive a wireless signal for D2D communication; and
a controller configured to control an operation of receiving, from a peer device, first resource information including a link identifier and start position information of resources to be allocated, calculating a Signal-to-Interference Ratio (SIR) for each resource slot based on measured received signal power from the peer device and an adjacent device, determining an adjusted resource start position and a resource allocation amount based on the calculated SIR, and transmitting, to the peer device, second resource information including at least one of the adjusted resource start position and the resource allocation amount.

31. The device of claim 30, wherein the controller is configured to determine the adjusted resource start position and the resource allocation amount to prevent collision with another D2D link.

32. The device of claim 30, wherein the controller is configured to control an operation of measuring received power of a signal received from each D2D link, measuring the SIR, and comparing the measured SIR with a preset threshold to determine whether to adjust resource information.

33. The device of claim 30, wherein the controller is configured to control an operation of determining that interference by another D2D link is low, if the SIR is greater than or equal to a preset threshold, determining that interference by another D2D link is high, if the SIR is less than the preset threshold, and generating, if the interference is high, the second resource information that is obtained by adjusting the first resource information considering a position of a slot.

34. The device of claim 30, wherein the controller is configured to control an operation of transmitting, to the peer device, bit information indicating whether to terminate the resource allocation in every slot.

35. The device of claim 30, wherein data transmission using the device of claim 30 is performed in either contention-free manner or contention-based manner.

36. The device of claim 30, wherein the contention-based manner denotes Carrier Sense Multiple Access with Collision Avoidance.
